(19) United States
(12) Patent Application Publication
(10) Pub. No.: US 2002/0157494 A1
(43) Pub. Date: Oct. 31, 2002

(54) Connection structure of extendable shaft

(76) Inventors: Sakae Matsumoto, Gunma-ken (JP); Tadashi Hibino, Gunma-ken (JP); Takeshi Negishi, Gunma-ken (JP); Satoshi Onozato, Gunma-ken (JP)

Correspondence Address: MILES & STOCKBRIDGE PC, 1751 PINNACLE DRIVE, SUITE 500, MCLEAN, VA, 22102-3833, US

(21) Appl. No.: 09/936,564

(22) PCT Filed: Mar. 26, 2001
(86) PCT No.: PCT/JP01/00532

(30) Foreign Application Priority Data
Jan. 27, 2000 (JP) 2000-019049

(51) Int. Cl. B62D 3/06

(52) U.S. Cl. 74/492

(57) ABSTRACT

A concave groove 3 formed in a male spline fitting portion 1a of an inner shaft 1 is filled with a synthetic resin via filling holes 4 formed in a female spline fitting portion 2a of an outer shaft 2. Resinous slide portions 5 are formed on the fitting portions 1a, 2a of these two shafts 1, 2. A resinous ring 6 is attached to an inner peripheral surface of a front side end of the female spline fitting portion 2a of the outer shaft 2, whereby even if the front side end of the outer shaft 2 comes off the male spline fitting portion 1a of the inner shaft 1, the front side end of the outer shaft 2, because of the resinous ring 6 sliding on an outer peripheral surface of a small-diameter portion 1b of the inner shaft 1, is capable of smoothly moving towards a front side of a vehicle.

### TECHNICAL FIELD

The present invention relates generally to a coupling structure of extensible shafts used for a steering apparatus etc of an automobile, and more particularly to a coupling structure of extensible shafts by which to enhance a mobility of an outer shaft toward a front side of the vehicle when collapsed upon a secondary collision.

### BACKGROUND ARTS

In a steering apparatus of an automobile, a steering shaft becomes shrunk by getting a part of a steering shaft collapsed upon a secondary collision, thus safeguarding a driver. A hollowed outer shaft disposed on a rear side of the steering shaft is spline-fitted (or serration-fitted) to a solid inner shaft disposed on a front side thereof, and fitting portions of these two shafts get collapsed upon the secondary collision, whereby the inner shaft is housed in the outer shaft and the steering shaft thus shrinks.

According to, for example, Japanese Patent Application Laid-Open Publications Nos. 2-286468 and 10-45006, a predetermined clearance is given to between the spline fitting portions of the two shafts, thereby well keeping an axial slidability between the two shafts. On the other hand, a concave groove formed in the inner shaft is filled by injection with a synthetic resin, thereby forming resinous slide portions on the spline fitting portions of the two shafts. A [backlash] occurred in a peripheral direction of the shafts is thereby prevented, and the two shafts can get shrunk with a stability when collapsed upon the secondary collision.

To be more specific, as shown in FIG. 4, a solid inner shaft 1 disposed on a front side of the steering shaft is spline-fitted (or serration-fitted) to a hollowed outer shaft 2 disposed on a rear side thereof. The inner shaft 1 is constructed of a male spline fitting portion 1a and a small-diameter portion 1b of which a diameter is set slightly smaller than a diameter of this fitting portion 1a. The outer shaft 2 is constructed of a female spline fitting portion 2a and a large-diameter portion 2b of which a diameter is set slightly larger than a diameter of this fitting portion 2a. A predetermined clearance is given to between the spline fitting portions 1a and 2a of the two shafts 1, 2, thereby well keeping an axial slidability between the two shafts 1 and 2.

The male spline fitting portion 1a of the inner shaft is formed with two streaks of concave grooves 3 extending over the entire periphery thereof. The female spline fitting portion 2a of the outer shaft 2 is formed with a plurality of filling holes 4 through which to make injection-filling of a synthetic resin, corresponding to those concave grooves 3. With this configuration, the concave grooves 3 are filled by injection with the synthetic resin through the filling holes 4, thus forming resinous slide portions 5 on the spline fitting portions 1a, 2a of the two shafts 1, 2. A [backlash] caused in a peripheral direction between the shafts 1 and 2 is thereby prevented, and the inner and outer shafts 1 and 2 can get shrunk with a stability when becoming collapsed upon a secondary collision.

In the steering shaft shown in FIG. 4, the spline fitting portions 1a, 2a of the two shafts 1, 2 get collapsed upon the secondary collision. As shown in FIG. 5, the female spline fitting portion 2a of the outer shaft 2 moves with respect to the male spline fitting portion 1a of the inner shaft towards the front side of the vehicle, with the result that the two shafts 1 and 2 get shrunk.

As the collapse occurred upon the secondary collision progresses, a [fitting length L] of the spline fitting portions 1a, 2a of the two shafts 1, 2 decreases as shown in FIG. 5. Then, the front side end of the outer shaft 2 comes off the male spline fitting portion 1a of the inner shaft 1.

When this collapse further progresses, as shown in FIG. 6, the [fitting length L] of the spline fitting portions 1a, 2a becomes much shorter, and the front side end of the outer shaft 2 comes further off the male spline fitting portion 1a of the inner shaft 1 and comes to be positioned on the outer periphery of the small-diameter portion 1b.

At this time, for example, if a bending load acts on the outer shaft 2, it might happen that the front side end of the outer shaft 2 is brought into contact with the outer peripheral surface of the small-diameter portion 1b of the inner shaft 1. As a result, the outer shaft 2 does not necessarily smoothly move towards the front side of the vehicle.

It is an object of the present invention, which was devised under such circumstances, to provide a coupling structure of extensible shafts by which to enhance a mobility of the outer shaft towards the front side of the vehicle when collapsed upon the secondary collision.

### DISCLOSURE OF INVENTION

A coupling structure of extensible shafts is characterized by comprising an inner shaft having a fitting portion, an outer shaft having a fitting portion so fitted to the fitting portion of the inner shaft as to be extensible in the axial direction and incapable of rotating, a concave groove formed in the fitting portion of the inner shaft, filling holes, formed in the fitting portion of the outer shaft, through which the concave groove is filled with a synthetic resin, and resinous slide portions thus formed on the fitting portions of the inner and outer shafts, wherein a low frictional member is attached to an inner peripheral surface of a front side end of the fitting portion of the outer shaft.

Thus, according to the present invention, the low frictional member is attached to the inner peripheral surface of the front side end of the outer shaft, and hence the outer shaft moves towards the front side of a vehicle when collapsed upon a secondary collision, with the result that a [fitting length] of the fitting portions of the two shafts decreases. Then, even if a bending load acts on the outer shaft when the front side end of the outer shaft comes off the fitting portion of the inner shaft and is positioned on an outer periphery of the small-diameter portion of the inner shaft, the front side end of the outer shaft, because of the low frictional member (a resinous ring) sliding on an outer peripheral surface of the small-diameter portion of the inner shaft, is capable of smoothly moving towards the front side of the vehicle. A mobility of the outer shaft toward the front side of the vehicle can be more enhanced than in the prior arts.

In the coupling structure according to the present invention, the low frictional member may preferably be a resinous ring composed of a polyacetal resin, polytetrafluoroethylene like nylon or Teflon (a brand name), and this ring may preferably be attached to an inner peripheral surface of the front side end of the outer shaft. The way of attaching the ring may preferably be such that the resinous ring is fitted into the inner peripheral surface of the front side end of the outer shaft and secured enough not to come off by caulking the front side end of the outer shaft, or the ring may also be press-fitted in or bonded to the inner peripheral surface of the front side end of the outer shaft.

### BRIEF DESCRIPTION OF THE DRAWINGS

FIG. 1 is a vertical sectional view showing a steering shaft for a vehicle, to which a coupling structure of extensible shafts in a first embodiment of the present invention is applied;

FIG. 2 is a view showing how the steering shaft for the vehicle illustrated in FIG. 1 acts upon a secondary collision;

FIG. 3 is a vertical sectional view showing the steering shaft for the vehicle, to which the coupling structure of extensible shafts in a second embodiment of the present invention is applied;

FIG. 4 is a vertical sectional view showing a steering shaft for a vehicle, to which a coupling structure of extensible shafts in the prior art is applied;

FIG. 5 is a view showing how the steering shaft for the vehicle illustrated in FIG. 4 acts upon the secondary collision in the prior art; and

FIG. 6 is a view showing how the steering shaft for the vehicle illustrated in FIG. 4 acts upon the secondary collision in the prior art, and also showing a case where a collapse progresses.

### BEST MODE FOR CARRYING OUT THE INVENTION

A coupling structure of extensible shafts will be explained by way of embodiments of the present invention with reference to the drawings.

(First Embodiment)

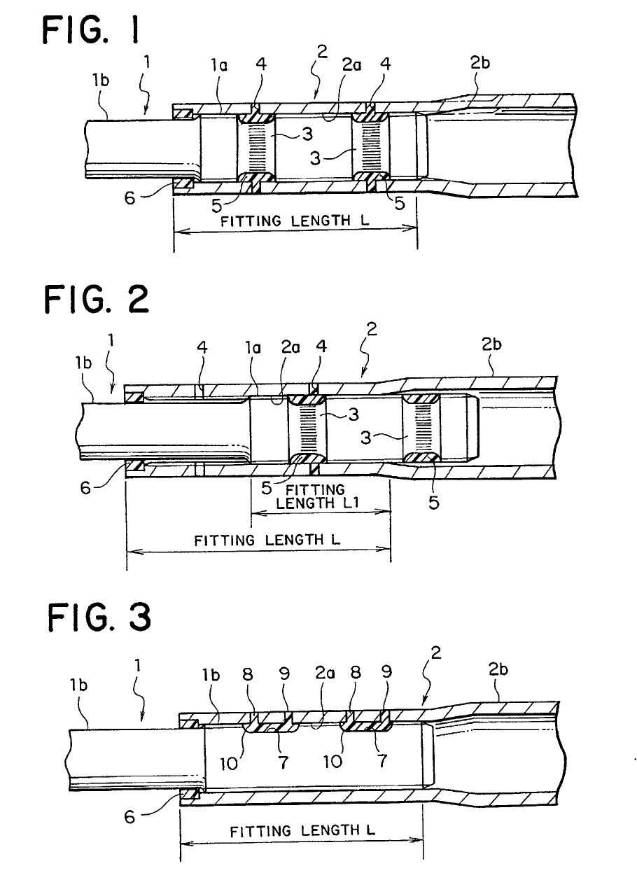

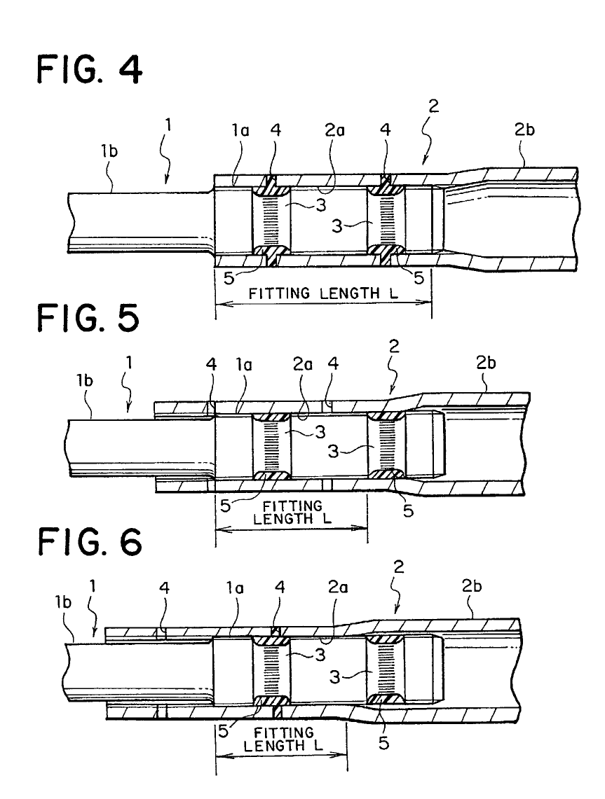

FIG. 1 is a vertical sectional view showing a steering shaft for a vehicle, to which the coupling structure of the extensible shafts in a first embodiment of the present invention is applied. FIG. 2 is a view showing how the steering shaft for the vehicle illustrated in FIG. 1 acts upon a secondary collision.

As shown in FIG. 1, a solid inner shaft 1 disposed on a front side of the steering shaft is spline-fitted (or serration-fitted) to a hollowed outer shaft 2 disposed on a rear side thereof. The inner shaft 1 is constructed of a male spline fitting portion 1a and a small-diameter portion 1b of which a diameter is set slightly smaller than a diameter of this fitting portion 1a. The outer shaft 2 is constructed of a female spline fitting portion 2a and a large-diameter portion 2b of which a diameter is set slightly larger than a diameter of this fitting portion 2a. A predetermined clearance is given to between the spline fitting portions 1a and 2a of the two shafts 1, 2, thereby well keeping an axial slidability between the two shafts 1, 2.

The male spline fitting portion 1a of the inner shaft is formed with two streaks of concave grooves 3 extending over the entire periphery thereof. The female spline fitting portion 2a of the outer shaft 2 is formed with a plurality of filling holes 4 through which to make injection-filling of a synthetic resin, corresponding to those concave grooves 3. With this configuration, the concave grooves 3 are filled by injection with the synthetic resin through the filling holes 4, thus forming resinous slide portions 5 on the spline fitting portions 1a, 2a of the two shafts 1, 2. A [backlash] caused in a peripheral direction between the shafts 1 and 2 is thereby prevented, and the inner and outer shafts 1, 2 can get shrunk with a stability when becoming collapsed upon a secondary collision.

According to the first embodiment, a low frictional member, i.e., a resinous ring 6 composed of a polyacetal resin, polytetrafluoroethylene like nylon or Teflon (a trade name) and so on, is fitted to an inner peripheral surface of a front side end of the female spline fitting portion 2a of the outer shaft 2. The way of fitting this ring 6 may be such that the resinous ring 6 is fitted into an annular cut portion in the inner peripheral portion of the front side end of the outer shaft 2 and secured enough not to come off by caulking the front side end of the outer shaft, or the ring 6 may also be press-fitted in or bonded to the annular cut portion. Note that a minute gap is formed between an inner peripheral surface of the resinous ring 6 and an outer peripheral surface of the small-diameter portion 1b.

Because of being configured as described above, the spline fitting portions 1a, 2a of the two shafts 1, 2 get collapsed upon the secondary collision. As shown in FIG. 2, the female spline fitting portion 2a of the outer shaft 2 moves with respect to the male spline fitting portion 1a of the inner shaft towards the front side of the vehicle, with the result that the two shafts 1 and 2 get shrunk.

As the collapse occurred upon the secondary collision progresses, a [fitting length L1] of the spline fitting portions 1a, 2a of the two shafts 1, 2 decreases as shown in FIG. 2. Then, the front side end of the outer shaft 2 comes off the male spline fitting portion 1a of the inner shaft 1 and comes to be positioned on the outer periphery of the small-diameter portion 1b of the inner shaft 1.

At this time, for example, even if a bending load acts on the outer shaft 2, according to the first embodiment, the resinous ring 6 is fitted to the inner peripheral surface of the front side end of the outer shaft 2 and therefore slides on the outer peripheral surface of the small-diameter portion 1b of the inner shaft 1, whereby the front side end of the outer shaft 2 can smoothly move toward the front side of the vehicle and a mobility of the outer shaft 2 toward the front side of the vehicle can be more enhanced than in the prior arts.

Moreover, as illustrated in FIG. 2, though the [fitting length L1] of the spline fitting portions 1a, 2a of the two shafts 1, 2 nominally decreases, if taking it into consideration that the resinous ring 6 slides on the outer peripheral surface of the small-diameter portion 1b of the inner shaft 1, a comparatively large initial [fitting length L] can be substantially ensured, and, as described above, the outer shaft 2 can smoothly move towards the front side of the vehicle.

Note that if the female spline fitting portion 2a of the outer shaft 2 is, as indicated by an imaginary line (two-dotted line) in FIG. 1, set equal to or longer than the [fitting length L], the [fitting length L1] can be increased as the collapse progresses.

(Second Embodiment)

FIG. 3 is a vertical sectional view showing a steering shaft for a vehicle, to which the coupling structure of the extensible shafts in a second embodiment of the present invention is applied.

In the second embodiment, the male spline fitting portion 1a of the inner shaft 1 has two streaks of segmental concave grooves 7 formed only in some portions in the peripheral direction. Further, the female spline fitting portion 2a of the outer shaft 2 is formed with two pieces of injection holes 8 for injecting the synthetic resin and with two pieces of discharge holes 9 for discharging the synthetic resin. With this configuration, when filled with the synthetic resin by injection, the synthetic resin is injected into the segmental concave grooves 7 via the injection holes 8. If the resin overflows, the overflowed resin is discharged via the discharge holes 9. Resinous slide portions 10 are thus formed in the concave grooves 7.

As described above, the male spline fitting portion 1a of the inner shaft 1 is formed with the segmental concave grooves 7 only in some portions in the peripheral direction. Therefore, the resin filling there does not spread wider than needed over the entire peripheries of the two fitting portions 1a, 2a, and it is feasible to restrain a slide resistance on the resinous slide portion 10 from remarkably increasing.

Further, when filled with the synthetic resin by injection, the overflowed synthetic resin is discharged via the discharge holes 9, and hence the interiors of the two fitting portions 1a, 2a are not filled with more of the resin than needed. Similarly, it is possible to restrain the slide resistance on the resinous slide portion 10 from remarkably increasing.

Moreover, in the second embodiment also, as the collapse occurred upon the secondary collision progresses, the front side end of the outer shaft 2 comes off the male spline fitting portion 1a. Then, if positioned on the outer periphery of the small-diameter portion 1b, the resinous ring 6 is attached to the inner peripheral surface of the front side end of the outer shaft 2 and therefore slides on the outer peripheral surface of the small-diameter portion 1b of the inner shaft 1. Accordingly, the front side end of the outer shaft 2 is capable of smoothly moving towards the front side of the vehicle, and the mobility of the outer shaft 2 toward the front side of the vehicle can be more enhanced than in the prior arts.

Note that the present invention is not limited to the embodiments discussed above and may be modified in a variety of forms.

According to the present invention, the low frictional member (e.g., the resinous ring) is attached to the inner peripheral surface of the front side end of the fitting portion of the outer shaft, and therefore, when getting collapsed upon the secondary collision, the outer shaft moves towards the front side of the vehicle, and the [fitting length] of the fitting portions of the two shafts decreases, with the result that the front side end of the outer shaft comes off the fitting portion of the inner shaft. Then, even if the bending load acts on the outer shaft when positioned on the outer periphery of the small-diameter portion of the inner shaft, the front side end of the outer shaft slides on the outer peripheral surface of the small-diameter portion of the inner shaft and is therefore capable of smoothly moving towards the front side of the vehicle, and the mobility of the outer shaft toward the front side of the vehicle can be more enhanced than in the prior arts.

What is claimed is:

1. A coupling structure of extensible shafts, characterized by comprising:
an inner shaft having a fitting portion;
an outer shaft having a fitting portion so fitted to said fitting portion of said inner shaft as to be extensible in the axial direction and incapable of rotating;
a concave groove formed in said fitting portion of said inner shaft;
filling holes, formed in said fitting portion of said outer shaft, through which said concave groove is filled with a resin; and
resinous slide portions thus formed on said fitting portions of said inner and outer shafts,
wherein a low frictional member is attached to an inner peripheral surface of a front side end of said fitting portion of said outer shaft.

2. A coupling structure of extensible shafts according to claim 1, characterized in that said low frictional member is constructed of a ring made of a synthetic resin.
